(19) United States
(12) Patent Application Publication
(10) Pub. No.: US 2026/0042705 A1
(43) Pub. Date: Feb. 12, 2026

(54) CHROMATIC RADIATIVE COOLING DEVICE

(71) Applicant: KOREA INSTITUTE OF SCIENCE AND TECHNOLOGY, Seoul (KR)

(72) Inventors: Jin Gu KANG, Seoul (KR); Sangwok BAE, Seoul (KR); Minjeong KIM, Seoul (KR); In Soo KIM, Seoul (KR); Jae-Gwan PARK, Seoul (KR); Min Ji KIM, Seoul (KR)

(73) Assignee: KOREA INSTITUTE OF SCIENCE AND TECHNOLOGY, Seoul (KR)

(21) Appl. No.: 19/204,037

(22) Filed: May 9, 2025

Related U.S. Application Data
(63) Continuation of application No. PCT/KR2024/017788, filed on Nov. 11, 2024.

(30) Foreign Application Priority Data
Aug. 7, 2024 (KR) 10-2024-0105542

(51) Int. Cl. C03C 17/36

(52) U.S. Cl. CPC C03C 17/3642; C03C 17/3649; C03C 2217/252; C03C 2217/70; C03C 2218/116

(57) ABSTRACT

The present invention relates to a color-developing radiative cooling device including a liquid crystal layer containing a cholesteric liquid crystal having a pitch range of 50 nm to 550 nm, wherein the cholesteric liquid crystal includes a reactive mesogen compound and a chiral dopant, thereby implementing various colors while maintaining excellent cooling performance.

### CROSS-REFERENCE TO RELATED APPLICATIONS

The present application is a continuation of International Patent Application No. PCT/KR2024/017788, filed Nov. 11, 2024, which is based upon and claims the benefit of priority to Korean Patent Application No. 10-2024-0105542, filed on Aug. 7, 2024. The disclosures of the above-listed applications are hereby incorporated by reference in their entirety.

### BACKGROUND

### Technical Field

The present invention relates to a color-developing radiative cooling device that implements various colors and exhibits cooling performance without external power.

### Description of Related Art

For cooling, the consumption of energy is essential. Currently, cooling devices such as refrigerators and air conditioners use electrical energy to compress a refrigerant, and then perform cooling by utilizing the absorption of heat generated when the compressed refrigerant is expanded. Meanwhile, radiative cooling technology can cool without the consumption of energy.

In order to achieve radiative cooling, it is necessary to control the absorption, reflection, and emission of light independently in each wavelength range. In most cases, the heat source is incident sunlight. The heat of sunlight is distributed in the UV-visible-near-infrared region, and by reflecting the light in this wavelength range, the influx of heat through sunlight may be blocked and released.

For heat emission, it is desirable to emit heat well into space by having high absorptivity or emissivity in the long-wavelength infrared region.

According to the Planck distribution, at a temperature of 300 K, the maximum heat emission occurs in the wavelength range of 6-20 μm. For the Earth, the atmospheric window region is about 8-13 μm. Therefore, in order to maximize the heat emission capability of a passive cooling device, the absorptivity or emissivity in the 8-13 μm range should be at its maximum.

Infrared radiation in the atmospheric window wavelength range plays a key role in achieving radiative cooling through actual thermal emission. If one could reflect 100% of the sunlight in the UV-visible-near-infrared range, which is radiation from the sun, and radiate 100% of the long-wavelength infrared in the 8 μm-13 μm range, the atmospheric window, then a cooling performance of 158 W/m2 could be achieved at 300 K without any energy consumption.

In some embodiments, a radiative cooling device may be used in automobiles, buildings, and containers to reduce the energy burden required for cooling. To achieve color expression, only specific wavelengths of light must be reflected, and the remaining wavelengths should be blocked from being absorbed to facilitate cooling. However, conventional radiative cooling devices capable of high reflection of sunlight are formed of metals, and while they reflect specific wavelengths, they absorb the rest, which raises the temperature of objects inside. If even a portion of sunlight is absorbed by an internal object, achieving a temperature range lower than the ambient temperature is difficult. Thus, conventional radiative cooling devices have limitations in simultaneously providing both color implementation and cooling performance.

### SUMMARY

The problem to be solved by the present invention is to provide a color-developing radiative cooling device that implements various colors under sunlight while exhibiting excellent cooling performance.

According to one embodiment of the present invention, there is provided a color-developing radiative cooling device including a liquid crystal layer having a cholesteric liquid crystal, the cholesteric liquid crystal including a reactive mesogen compound and a chiral dopant, and having a pitch range of 50 nm or more to 550 nm or less.

The mesogen compound may be represented by any one of Chemical Formulas 1 to 4 below.

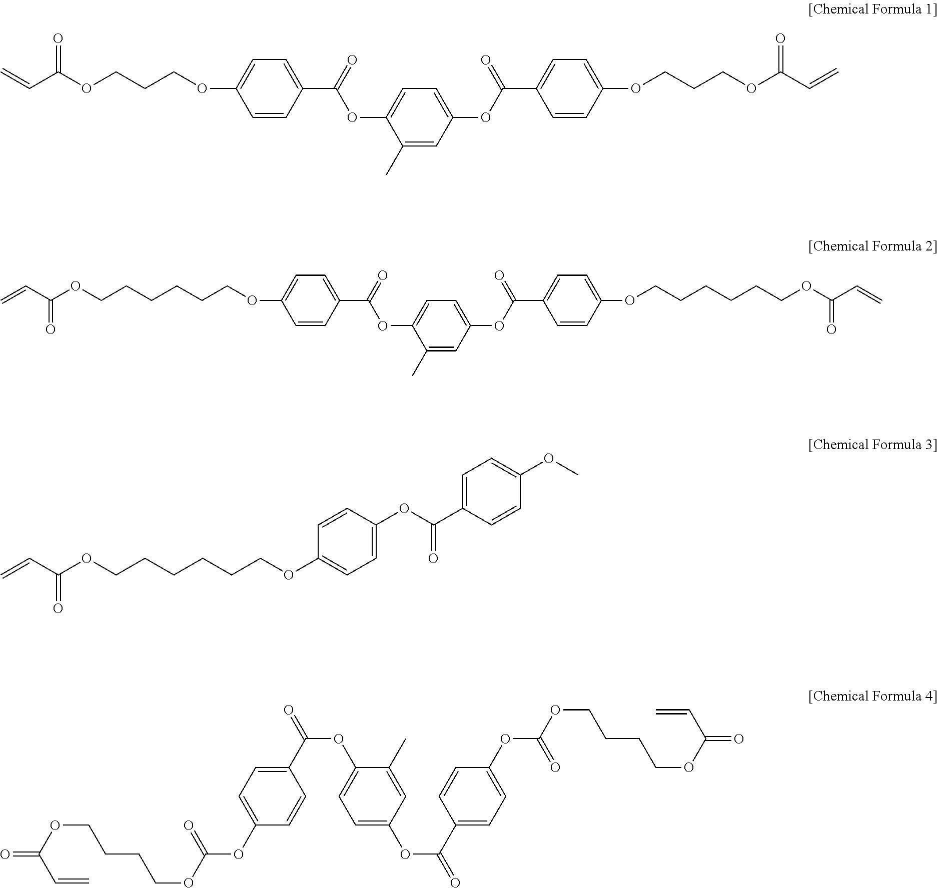

The color-developing radiative cooling device may further include a protective film layer formed on top of the liquid crystal layer.

The protective film layer of the color-developing radiative cooling device may be made of a polymer or an inorganic material.

The polymer may include at least one selected from PDMS (Polydimethyl siloxane), PMMA (Poly(methyl methacrylate)), PVDF (Polyvinylidene fluoride), PUA (Poly urethane acrylate), PET (polyethylene terephthalate), PVC (polyvinyl chloride), and DPHA (Dipentaerythritol Hexaacrylate).

The inorganic material may include at least one selected from SiO₂, Al₂O₃, Ta₂O₅, CaSO₄, MgHPO₄, ZrO₂, BaSO₄, AlPO₄, HfO₂, and Y₂O₃.

The color-developing radiative cooling device may further include a reflective layer formed under the liquid crystal layer.

The reflective layer may include at least one selected from gold (Au), copper (Cu), titanium (Ti), chromium (Cr), manganese (Mn), iron (Fe), silver (Ag), aluminum (Al), and platinum (Pt).

The color-developing radiative cooling device may further include a substrate layer formed under the reflective layer, the substrate layer being selected from an Si wafer, glass, and a PET (polyethylene terephthalate) film.

The color-developing radiative cooling device may further include a transmissive layer formed under the liquid crystal layer.

The transmissive layer may be selected from glass, PET (polyethylene terephthalate), and ITO (Indium tin oxide).

According to one embodiment of the present invention, the color-developing radiative cooling device may include a liquid crystal layer including a cholesteric liquid crystal, which includes a reactive mesogen compound and a chiral dopant and has a pitch range of 50 nm to 550 nm, making it possible to maintain excellent cooling performance while implementing various colors. Accordingly, it may be applied to buildings, electronic devices, and the like, where cooling and aesthetic appearance are simultaneously required.

The effect of the present invention is not limited to the aforementioned effects, and other effects not mentioned will be clearly understood by those skilled in the art from this specification and the accompanying drawings.

### BRIEF DESCRIPTION OF DRAWINGS

FIGS. 1A to 1G are views illustrating a color-developing radiative cooling device according to one embodiment of the present invention.

FIG. 2 is a conceptual diagram of the cholesteric liquid crystal included in the liquid crystal layer according to one embodiment of the present invention.

FIG. 3 is an SEM image of the cross-section of the color-developing radiative cooling device according to Example 1.

FIG. 4 is a UV-Vis diffuse reflectance spectrum of the color-developing radiative cooling device according to Example 1.

FIGS. 5A to 5C are images showing the color development appearances of cooling devices according to Example 1, Example 3, and Example 4, respectively.

FIG. 6 is a graph showing the infrared absorption and emissivity of the color-developing radiative cooling device according to Example 1.

FIG. 7 is a graph explaining an outdoor environment daytime external temperature change experiment for Example 1, Example 2, and Comparative Example 1.

### DETAILED DESCRIPTION

Hereinafter, embodiments of the present invention will be described in detail with reference to the accompanying drawings.

Throughout this specification, when a certain part is said to “include” a certain component, it means that another component may be further included unless specifically stated otherwise, rather than excluding the other component.

Throughout this specification, when a certain member is said to be “on” another member, this includes not only cases where the certain member is in contact with the other member, but also cases where yet another member is interposed between the two members.

Throughout this specification, a cholesteric liquid crystal refers to a chiral nematic liquid crystal formed by adding a chiral dopant or a photo-sensitive chiral dopant that induces a periodic helical structure in a nematic liquid crystal, and an additive such as a photoinitiator may be further included during formation.

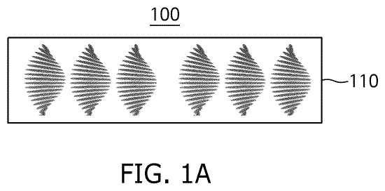

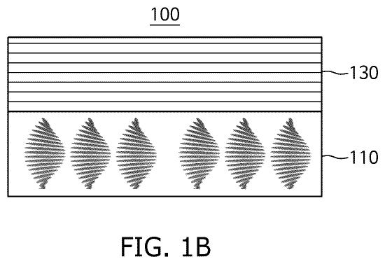

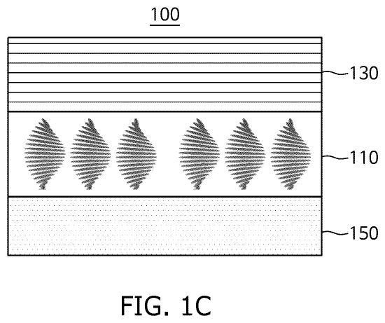

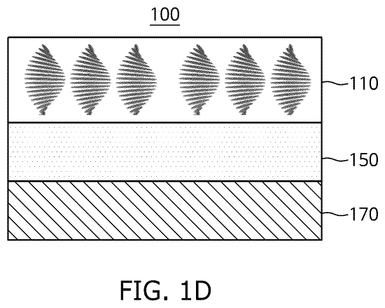

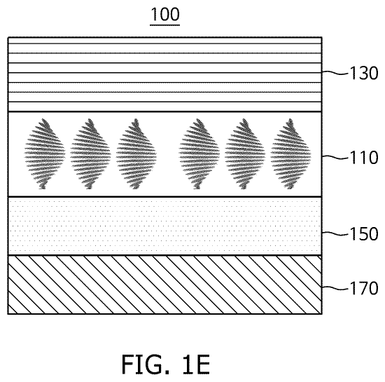

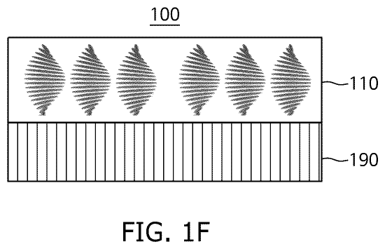

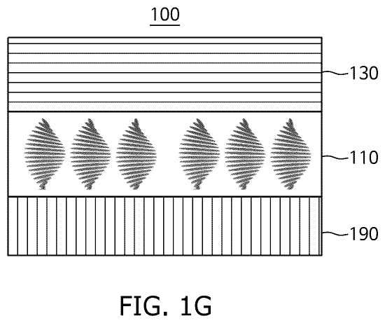

FIGS. 1A to 1G schematically show the structure of a color-developing radiative cooling device according to one embodiment of the present invention. The structure of the color-developing radiative cooling device will be described in further detail below with reference to FIGS. 1A to 1G.

FIG. 1A is a schematic diagram showing a color-developing radiative cooling device that includes a liquid crystal layer 110 according to one embodiment of the present invention.

In one embodiment of the present invention, there is provided a color-developing radiative cooling device including a liquid crystal layer including a cholesteric liquid crystal having a pitch range of 50 nm to 550 nm, wherein the cholesteric liquid crystal contains a reactive mesogen compound and a chiral dopant.

FIG. 1A exemplifies a structure in which the color-developing radiative cooling device 100 according to one embodiment of the present invention is formed as a single structure of the liquid crystal layer 110.

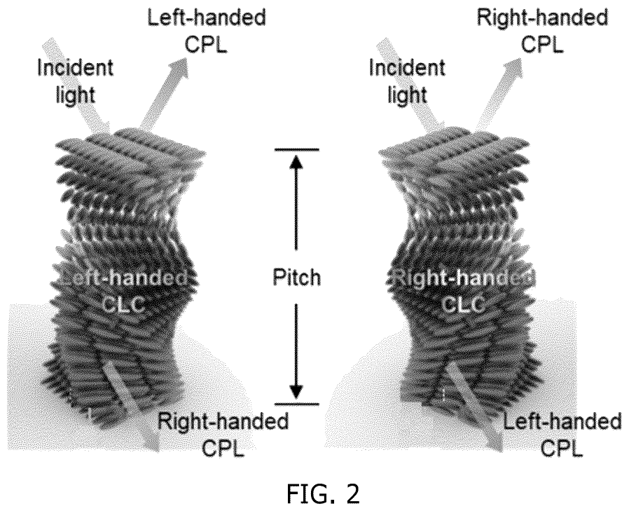

FIG. 2 is a conceptual diagram of the cholesteric liquid crystal included in the liquid crystal layer 110 according to one embodiment of the present invention. Specifically, it shows that by adjusting the alignment direction, it is possible to implement both left-handed and right-handed directions. The cholesteric liquid crystal may exhibit color due to the light reflected by the pitch of its helical structure. Further, the cholesteric liquid crystal can adjust the color expressed by absorbing and emitting different colors depending on the type of photoreactive mesogen compound, the type and concentration of the chiral dopant, and external stimuli.

Moreover, the wavelength of reflected light is determined by the pitch (p) of the cholesteric liquid crystal. A longer pitch reflects a longer wavelength region in the red series, and a shorter pitch reflects a shorter wavelength region in the blue series. By controlling the pitch of the cholesteric liquid crystal, it is also possible to reflect a wavelength band near 550 nm in the visible spectrum, such as green. Because the cholesteric liquid crystal according to one embodiment of the present invention has a pitch range of 50 nm to 550 nm, various desired colors may be implemented. Therefore, because the color-developing radiative cooling device according to one embodiment of the present invention includes a liquid crystal layer containing a cholesteric liquid crystal, it may implement various colors, and by diffusely reflecting light, those colors may be vividly expressed even under sunlight.

According to one embodiment of the present invention, the reactive mesogen compound may be represented by any one of Chemical Formulas 1 to 4 below, but it is not limited thereto.

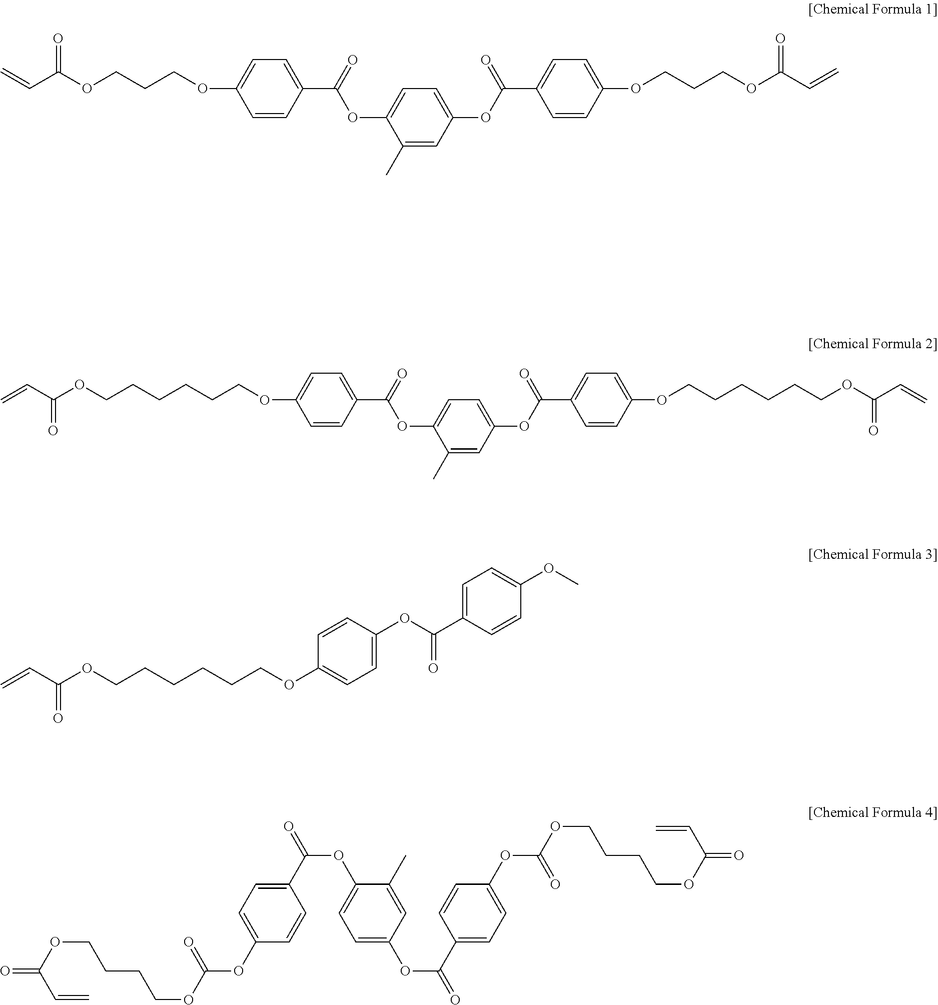

Specifically, the mesogen compounds represented by Chemical Formulas 1 to 4 each contain multiple functional groups such as C—O, C—O—C, C—F, or C—H that absorb or emit infrared in the 8 μm to 13 μm wavelength range of the atmospheric transparency layer, and thus exhibit high absorptivity or emissivity in the infrared region, thereby providing excellent cooling characteristics. Additionally, because mesogens have isomeric properties, by altering their content, it is possible to control phase change, transmission, scattering, and reflection, thereby adjusting the implemented color and temperature; by diffusely reflecting light, vivid colors can be achieved even under sunlight.

In one embodiment of the present invention, the chiral dopant may be selected according to the color to be implemented, for example LC756 or S-811, but is not limited thereto.

Referring to FIG. 1B, the color-developing radiative cooling device 100 according to one embodiment of the present invention may further include a protective film layer 130 formed on top of the liquid crystal layer 110. Specifically, by including the protective film layer, it is possible to prevent physical or chemical modification of the liquid crystal layer and to aid infrared absorption and emission of the liquid crystal layer.

According to one embodiment of the present invention, the protective film layer may be made of a polymer or an inorganic material. Specifically, because it is composed of a polymer or an inorganic material, it may absorb and emit infrared light to improve radiative cooling performance.

In one embodiment of the present invention, the polymer may be at least one selected from PDMS (Polydimethyl siloxane), PMMA (Poly(methyl methacrylate)), PVDF (Polyvinylidene fluoride), PUA (Poly urethane acrylate), PET (polyethylene terephthalate), PVC (polyvinyl chloride), and DPHA (Dipentaerythritol Hexaacrylate). Because the polymer has high emissivity across all infrared wavelength ranges, its radiative cooling performance may be superior.

According to one embodiment of the present invention, the inorganic material may include at least one selected from SiO₂, Al₂O₃, Ta₂O₅, CaSO₄, MgHPO₄, ZrO₂, BaSO₄, AlPO₄, HfO₂, and Y₂O₃. Because the polymer has high emissivity across all infrared wavelength ranges, its radiative cooling performance may be superior.

Referring to FIG. 1C, the color-developing radiative cooling device according to one embodiment of the present invention may further include a reflective layer 150 formed under the liquid crystal layer 110. Specifically, because the reflective layer is formed under the liquid crystal layer, it may further reflect infrared rays that are not reflected by the liquid crystal layer, thereby improving cooling performance.

In one embodiment of the present invention, the reflective layer may include at least one selected from gold (Au), copper (Cu), titanium (Ti), chromium (Cr), manganese (Mn), iron (Fe), silver (Ag), aluminum (Al), and platinum (Pt). Specifically, because the reflective layer is a specular metal, it may more easily reflect infrared rays not reflected by the liquid crystal layer, thereby improving cooling performance.

Referring to FIG. 1D or FIG. 1E, the color-developing radiative cooling device 100 according to one embodiment of the present invention may further include a substrate layer 170, selected from an Si wafer, glass, or a PET (polyethylene terephthalate) film, formed under the reflective layer 150. By including the substrate layer, the durability of the manufactured color-developing radiative cooling device may be enhanced.

Referring to FIG. 1F or FIG. 1G, the color-developing radiative cooling device according to one embodiment of the present invention may further include a transmissive layer 190 formed under the liquid crystal layer 110.

In one embodiment of the present invention, the transmissive layer may be selected from glass, PET (polyethylene terephthalate), or ITO (Indium tin oxide). Furthermore, because the transmissive layer is made of a transparent material, it may form a transparent device through which the inside is visible by transmitting part of the light.

Hereinafter, the present invention will be described in more detail by way of preferred examples. However, these examples are intended to illustrate the present invention in more detail, and it will be apparent to those of ordinary skill in the art that the scope of the present invention is not limited thereby.

### Example 1

In a 10 mL flat-bottom vial equipped with a stir bar, a mesogen compound (LC242, Daken Chemical), a chiral dopant (ISO(6OBA)2, 4-Chem Lab.), a photoinitiator (2,2-dimethoxy-2-phenylacetophenone, Sigma-Aldrich), and xylene (0.44 g) were placed. The weight ratio of the mesogen compound, chiral dopant, and photoinitiator was varied from 94.8:5.2:1 to 92.8:7.2:1 depending on the color, with a total weight of 1 g maintained. While stirring the mixed solution, it was heated at 110° C. for 2 hours to prepare a composition for forming a liquid crystal film. This composition was coated onto a silicon wafer having an aluminum metal reflector laminated thereon, followed by spin-coating at 500 rpm for 4 seconds and then additionally at 9000 rpm for 40 seconds. After standing in a drying oven at 80° C. for 2 minutes, UV curing was carried out at 85° C. under a nitrogen atmosphere for 15 minutes to form a liquid crystal layer with a thickness of about 5 μm.

### Example 2

A 100 μm-thick protective film layer composed of PDMS was further laminated on top of the liquid crystal layer prepared in Example 1.

### Example 3

It was prepared in the same manner as Example 2 except that the silicon wafer layer was removed from Example 2.

### Example 4

In a 10 mL flat-bottom vial equipped with a stir bar, a mesogen compound (LC242, Daken Chemical), a chiral dopant (ISO(6OBA)2, 4-Chem Lab.), a photoinitiator (2,2-dimethoxy-2-phenylacetophenone, Sigma-Aldrich), and xylene (0.44 g) were placed. The weight ratio of the mesogen compound, chiral dopant, and photoinitiator was varied from 94.8:5.2:1 to 92.8:7.2:1 depending on the color, with a total weight of 1 g maintained. While stirring the mixed solution, it was heated at 110° C. for 2 hours to prepare a composition for forming a liquid crystal film. This composition was coated onto a glass substrate, followed by spin-coating at 500 rpm for 4 seconds and then additionally at 9000 rpm for 40 seconds. After standing in a drying oven at 80° C. for 2 minutes, UV curing was carried out at 85° C. under a nitrogen atmosphere for 15 minutes to form a liquid crystal layer with a thickness of about 5 μm.

### Comparative Example 1

A control sample was prepared using a commercial radiative cooling paint (Commercial Paint) from JEVISCO Co.: red-orange (SD 1147), green (TN 0349), and blue (CL 1124). Each paint was applied undiluted, in an amount of 2 mg, onto a silicon wafer laminated with an aluminum metal reflector, and then spin-coated at 500 rpm for 5 seconds and subsequently at 2000 rpm for 20 seconds to form a 200 μm-thick layer. The coated paint layer was dried overnight in air at room temperature (25° C.).

### Characteristic Evaluation

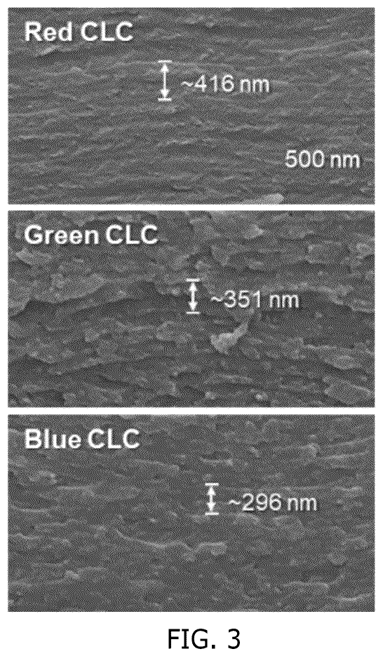

FIG. 3 is an SEM image of the cross-section of the color-developing radiative cooling device according to Example 1. Referring to FIG. 3, it was confirmed that color may be implemented according to the size of the pitch of the cholesteric liquid crystal.

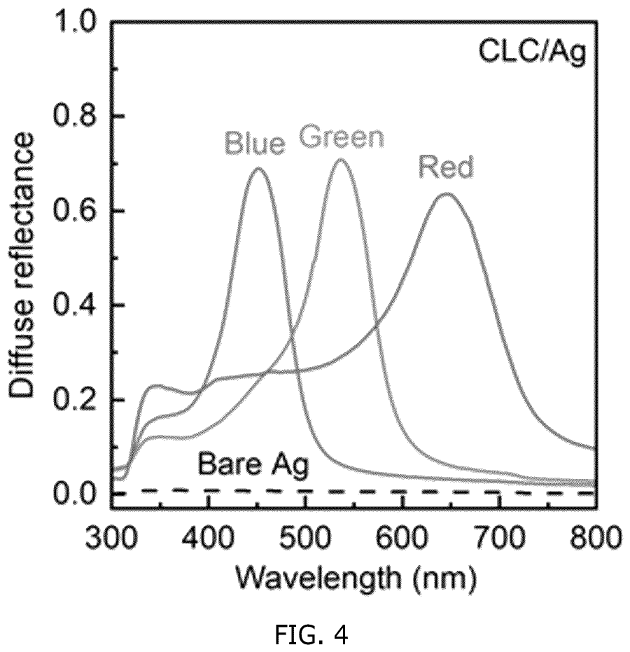

FIG. 4 is a UV-Vis diffuse reflectance spectrum of the color-developing radiative cooling device according to Example 1. Referring to FIG. 4, because the liquid crystal layer includes a cholesteric liquid crystal with a curved (curve) structure, it was confirmed that diffuse reflection is possible for all colors-red, green, and blue.

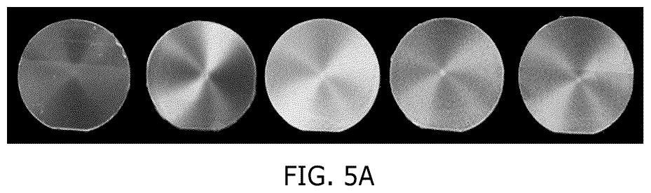

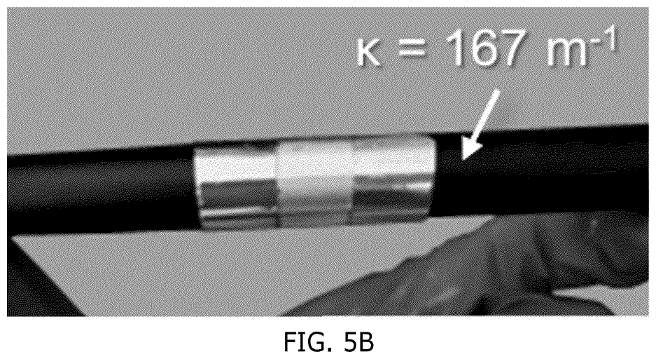

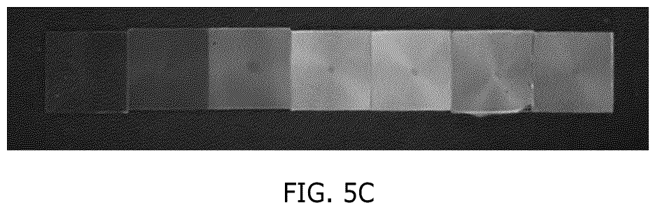

FIGS. 5A to 5C are images showing the color development appearances of cooling devices according to Example 1, Example 3, and Example 4, respectively. Referring to FIG. 5, it was confirmed that the manufactured color-developing radiative cooling device can implement a variety of colors from blue to red, without being limited to the opaque forms of Example 1 or Example 3 or the translucent form of Example 4. In particular, referring to FIG. 5B, it was confirmed that the color-developing radiative cooling device manufactured according to Example 3 has excellent flexibility and that color development performance is maintained even when bent.

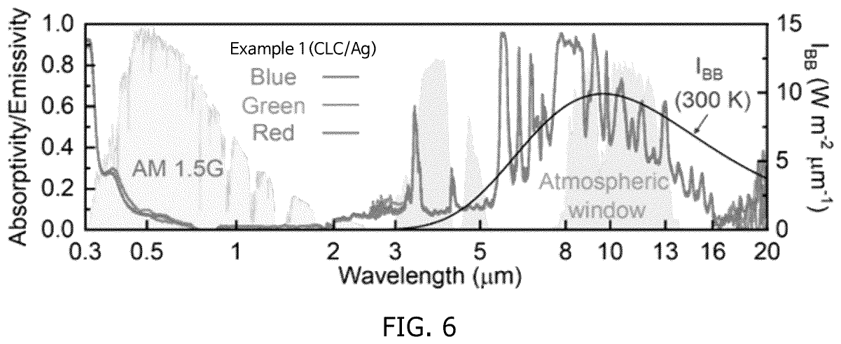

FIG. 6 is a graph showing the infrared absorption and emissivity of the color-developing radiative cooling device according to Example 1. Specifically, it was confirmed that it has high absorptivity and emissivity in the long-wavelength infrared region of 8 μm to 13 μm corresponding to the atmospheric window.

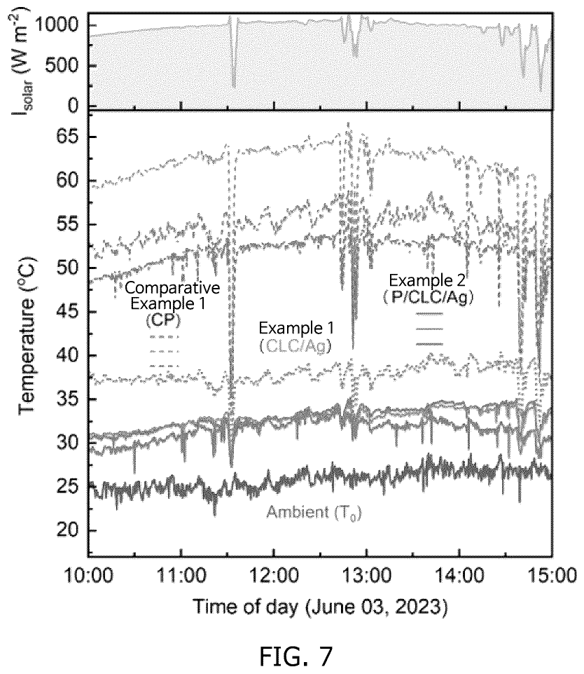

FIG. 7 is a graph explaining an outdoor daytime external temperature change experiment for Example 1, Example 2, and Comparative Example 1 conducted on Jun. 3, 2023. Referring to FIG. 7, it was confirmed that both Example 1 and Example 2 exhibited temperatures at least 30 degrees lower than those of Comparative Example 1, thereby demonstrating excellent cooling performance.

What is claimed is:

1. A color-developing radiative cooling device comprising a liquid crystal layer that comprises a cholesteric liquid crystal having a pitch range of 50 nm to 550 nm, the cholesteric liquid crystal including a reactive mesogen compound and a chiral dopant.

2. The color-developing radiative cooling device according to claim 1, wherein the reactive mesogen compound is represented by any one of Chemical Formulas 1 to 4 below:

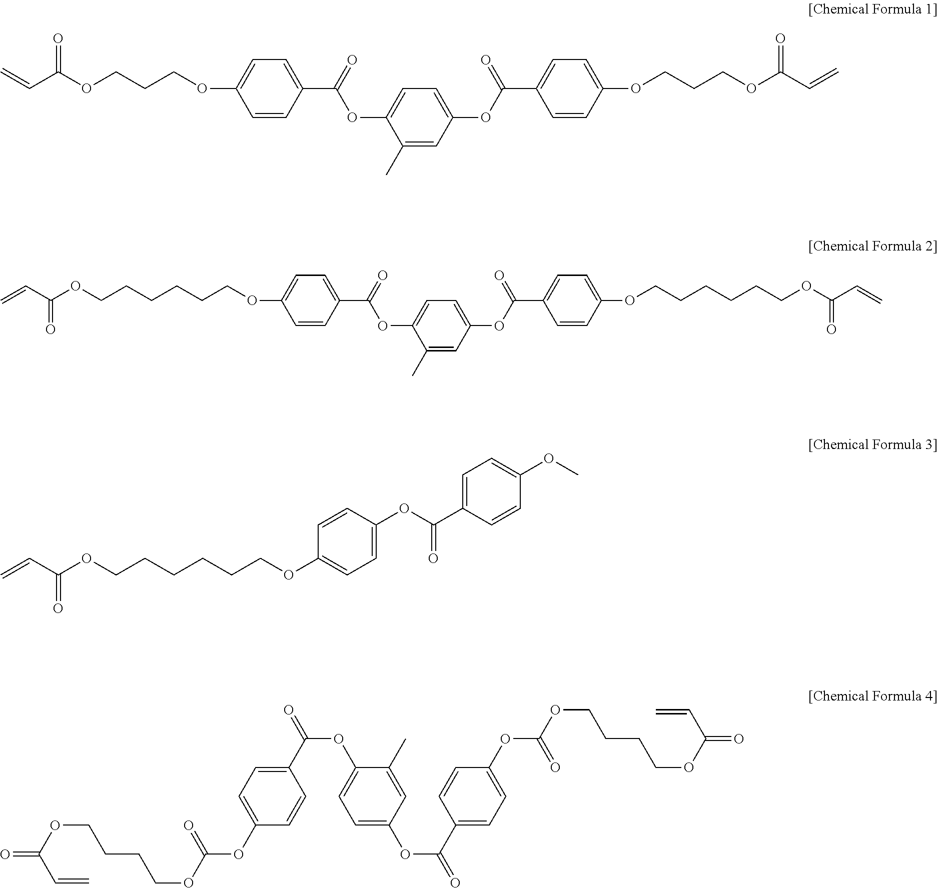

3. The color-developing radiative cooling device according to claim 1, further comprising a protective film layer formed on top of the liquid crystal layer.

4. The color-developing radiative cooling device according to claim 3, wherein the protective film layer is made of a polymer or an inorganic material.

5. The color-developing radiative cooling device according to claim 4, wherein the polymer comprises at least one selected from PDMS (Polydimethyl siloxane), PMMA (Poly(methyl methacrylate)), PVDF (Polyvinylidene fluoride), PUA (Poly urethane acrylate), PET (polyethylene terephthalate), PVC (polyvinyl chloride), and DPHA (Dipentaerythritol Hexaacrylate).

6. The color-developing radiative cooling device according to claim 4, wherein the inorganic material comprises at least one selected from SiO₂, Al₂O₃, Ta₂O₅, CaSO₄, MgHPO₄, ZrO₂, BaSO₄, AlPO₄, HfO₂, and Y₂O₃.

7. The color-developing radiative cooling device according to claim 1, further comprising a reflective layer formed under the liquid crystal layer.

8. The color-developing radiative cooling device according to claim 7, wherein the reflective layer comprises at least one selected from Au, Cu, Ti, Cr, Mn, Fe, Ag, Al, and Pt.

9. The color-developing radiative cooling device according to claim 7, further comprising a substrate layer formed under the reflective layer, which is selected from an Si wafer, glass, and a PET (polyethylene terephthalate) film.

10. The color-developing radiative cooling device according to claim 1, further comprising a transmissive layer formed under the liquid crystal layer.

11. The color-developing radiative cooling device according to claim 10, wherein the transmissive layer comprises any one selected from glass, PET, and ITO.
